(19) United States
(12) Patent Application Publication
(10) Pub. No.: US 2008/0138692 A1
(43) Pub. Date: Jun. 12, 2008

(54) FUEL CELL APPARATUS

(75) Inventor: Satoshi Mogi, Yamato-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/942,155

(22) Filed: Nov. 19, 2007

(30) Foreign Application Priority Data
Dec. 6, 2006 (JP) 2006-329948

(51) Int. Cl. H01M 8/02

(52) U.S. Cl. 429/34

(57) ABSTRACT

The present invention provides a fuel cell apparatus in which stable power generation can be performed by achieving both temperature control and humidity control with a simple structure, whereby enabling downsizing of the fuel cell apparatus. The fuel cell apparatus which uses air as an oxidizer includes: a fuel cell stack including multiple fuel cell units laminated to each other; an oxidizer flow path having a first opening portion and a second opening portion at both ends thereof, for supplying the air to the multiple fuel cell units; a manifold for covering at least a part of the first opening portion; a first blowing unit provided to the manifold, for ensuring an air amount required for power generation in the fuel cell stack; and a second blowing unit provided to the manifold, for controlling a humidity state of the fuel cell stack.

### BACKGROUND OF THE INVENTION

1. Field of the Invention

The present invention relates to a fuel cell apparatus, and more particularly, to a fuel cell apparatus in which both temperature control and humidity control are achieved.

2. Description of the Related Art

Fuel cell apparatuses are constructed so that a fuel gas and an oxidizer gas such as air are supplied thereto to perform power generation and have a potential for allowing a suppliable energy amount per volume to be several to ten times compared to a related art battery.

Further, by being charged with a fuel, the fuel cell apparatuses enable long-term use of small electronic devices such as mobile phones and notebook personal computers, thereby being promising.

Among the fuel cell apparatuses, a polymer electrolyte fuel cell includes a polymer electrolyte membrane and a pair of electrodes arranged on both surfaces of the polymer electrolyte membrane. The polymer electrolyte fuel cell can be used at about room temperature. Further, the polymer electrolyte membrane is not in a liquid state, but is in a solid state, whereby having an advantage of being carried safely.

Performance of the polymer electrolyte fuel cell varies depending on ion conductivity of the polymer electrolyte membrane. However, the ion conductivity largely changes according to a moisture level of the polymer electrolyte membrane.

That is, when a “dried state” is reached, in which the moisture level of the polymer electrolyte membrane is reduced, the ion conductivity of the polymer electrolyte membrane is remarkably reduced. As a result, increase in internal resistance occurs, thereby an output of the polymer electrolyte fuel cell decreases (dry-out phenomenon).

Accordingly, for power generation of the polymer electrolyte fuel cell, it is necessary that the polymer electrolyte membrane for conducting ions be moderately humidified.

On the other hand, in an atmosphere which is excessively humidified, an inside of a fuel cell unit is in an “excessively-humidified state”. Accordingly, flow of the oxidizer gas such as air is inhibited by existence of liquid water. As a result, the output of the polymer electrolyte fuel cell decreases (flooding phenomenon).

Further, even if an environmental atmosphere for the polymer electrolyte fuel cell is constant, an amount of water discharged by evaporation from the inside of the polymer electrolyte fuel cell varies depending on temperature in the polymer electrolyte fuel cell.

According to the above descriptions, in order to stably perform the power generation by the polymer electrolyte fuel cell, temperature and humidity need to be controlled appropriately depending on the environmental atmosphere or a power generation state.

In the related art, as a control system for the temperature and humidity of the fuel cell apparatus, there are known two systems including a separate gas system and a distribute gas system.

In the separate gas system, a cooling gas and the oxidizer gas are supplied independently of each other.

Further, in the distribute gas system, the cooling gas and the oxidizer gas are supplied from the same gas source and are distributed depending on a pressure loss in a cooling gas flow path and an oxidizer gas flow path. Accordingly, flow rates of the cooling gas and the oxidizer gas cannot be controlled independently of each other.

In the related art, as the separate gas system, Japanese Patent Application Laid-Open No. 2004-192974 proposes a fuel cell system in which individual flow rate control of the cooling gas and the oxidizer gas is enabled to realize the control of the temperature and the humidity of the polymer electrolyte fuel cell.

The fuel cell system has a structure in which, in a high-temperature state, the flow rate of the cooling gas is increased, in a low-temperature state, the flow rate of the cooling gas is reduced, in a high-humidity state, the flow rate of the oxidizer gas is increased, and in a low-humidity state, the flow rate of the oxidizer gas is reduced.

Further, in the related art distribute gas system, since the flow rates of the oxidizer gas and the cooling gas cannot be controlled independently of each other, the control of the temperature and the control of the humidity interfere with each other. Accordingly, it is difficult to set an optimum driving state.

That is, when a state of the fuel cell system tends to be the dried state, it is desirable that the flow rate of the cooling gas be increased and the flow rate of the oxidizer gas be reduced. However, in the distribute gas system, there is a problem in that the increase in the flow rate of the cooling gas involves increase in the flow rate of the oxidizer gas.

On the other hand, when the state of the fuel cell system tends to be the excessively-humidified state, it is desirable that the flow rate of the cooling gas be reduced and the flow rate of the oxidizer gas be increased. However, in the distribute gas system, there is a problem in that the reduction in the flow rate of the cooling gas involves reduction in the flow rate of the oxidizer gas.

In order to counter the above-mentioned problems, in the fuel cell system employing the distribute gas system, as disclosed in Japanese Patent Application Laid-Open No. 2003-317760, the oxidizer gas is supplied to the oxidizer flow path after humidification, thereby achieving the control of both the temperature and the humidity of the polymer electrolyte fuel cell.

However, the related art technology has the following problems with downsizing of the fuel cell apparatus.

For example, in an invention employing the separate gas system, as disclosed in Japanese Patent Application Laid-Open No. 2004-192974, in order to supply the cooling gas and the oxidizer gas, it is necessary that supplying units be provided individually for the cooling gas and the oxidizer gas, respectively.

Accordingly, a control unit for controlling the supplying units and spaces for installing the supplying units for the cooling gas and the oxidizer gas are required, so there arises a problem with achieving downsizing.

Further, in the fuel cell system employing the distribute gas system, as disclosed in Japanese Patent Application Laid-Open No. 2003-317760, a single supplying unit can be used in common for both the cooling gas and the oxidizer gas. However, it is necessary that a humidifier be provided for supplying the oxidizer gas to the oxidizer flow path after the humidification.

Accordingly, a space is required, so in the distribute gas system as well, there arises a problem with achieving downsizing.

### SUMMARY OF THE INVENTION

It is an object of the present invention to provide a fuel cell apparatus capable of performing stable power generation by achieving both temperature control and humidity control with a simple structure, whereby enabling downsizing of the fuel cell apparatus.

That is, the present invention provides a fuel cell apparatus structured as described below.

A fuel cell apparatus which uses air as an oxidizer includes: a fuel cell stack including multiple fuel cell units laminated to each other; an oxidizer flow path having a first opening portion and a second opening portion at both ends thereof, for supplying the air to the multiple fuel cell units; a manifold for covering at least a part of the first opening portion; a first blowing unit provided to the manifold, for ensuring an air amount required for power generation in the fuel cell stack; and a second blowing unit provided to the manifold, for controlling a humidity state of the fuel cell stack.

According to the fuel cell apparatus of the present invention, stable power generation can be performed by achieving both the temperature control and the humidity control with the simple structure, whereby enabling downsizing of the fuel cell apparatus.

Further features of the present invention will become apparent from the following description of exemplary embodiments with reference to the attached drawings.

### BRIEF DESCRIPTION OF THE DRAWINGS

FIG. 1 is a schematic exploded perspective view for describing a fuel cell apparatus according to an embodiment of the present invention.

FIGS. 2A and 2B are each a schematic view for describing a separator according to the embodiment of the present invention.

FIGS. 3A, 3B, and 3C are schematic sectional views taken along the line A-A of FIG. 1, for describing blowing directions according to the embodiment of the present invention.

FIG. 4 is a schematic diagram for describing control of a fuel cell apparatus according to the embodiment of the present invention.

FIGS. 5A, 5B, and 5C are schematic views for describing blowing directions which are different from those of FIGS. 3 according to the embodiment of the present invention.

FIGS. 6A, 6B, and 6C are views for describing structural examples of the separator according to the embodiment of the present invention, in which FIG. 6A is a schematic view illustrating the structural example in which heat radiation fins integrated with the separator are formed on a manifold side, FIG. 6B is a schematic view illustrating the structural example in which a conductive porous material is provided on the manifold side so as to protrude therefrom, and FIG. 6C is a schematic sectional view taken along the line A-A of FIG. 1 in a state where the separator of FIG. 6B is used.

FIG. 7 is a schematic graph for describing a structural example of a blowing fan which can be used in the embodiment of the present invention.

FIG. 8 is a schematic diagram for describing a method of electrically connecting the blowing fan to the fuel cell apparatus according to the embodiment of the present invention.

### DESCRIPTION OF THE EMBODIMENT

Hereinafter, a description will be made of a fuel cell apparatus according to an embodiment of the present invention.

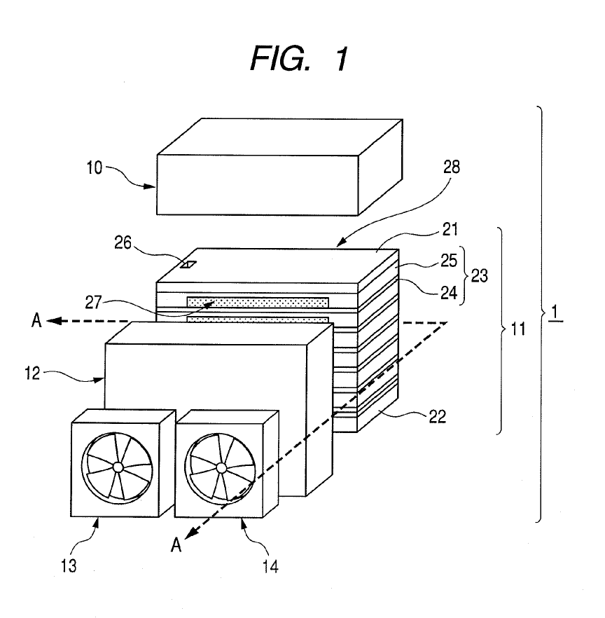

FIG. 1 is an exploded perspective view for describing the fuel cell apparatus according to this embodiment. There are provided a fuel cell apparatus 1, a fuel tank 10, a fuel cell stack 11, a manifold 12, a first blowing fan 13 serving as a first blowing unit, and a second blowing fan 14 serving as a second blowing unit.

End plates are denoted by reference numerals 21 and 22, a fuel cell unit is denoted by reference numeral 23, membrane electrode assembly is denoted by reference numeral 24, a separator is denoted by reference numeral 25, and a fuel flow path inlet is denoted by reference numeral 26.

The fuel cell apparatus 1 of this embodiment includes the fuel tank 10, the fuel cell stack 11, the manifold 12, the first blowing fan 13 serving as the first blowing unit, and the second blowing fan 14 serving as the second blowing unit.

The fuel tank 10 is charged with a hydrogen gas and supplies to the fuel cell stack 11 the hydrogen gas having a pressure controlled as needed.

In this embodiment, while power generation is performed by using the hydrogen gas stored in the fuel tank 10, a liquid fuel such as methanol may be supplied.

The fuel cell stack 11 is structured by laminating the multiple fuel cell units 23 between the pair of end plates 21 and 22.

Further, each of the fuel cell units 23 includes the membrane electrode assembly 24 and the separator 25.

The membrane electrode assembly 24 is provided with catalyst layers made of platinum fine particles or the like, catalyst layers being formed on surfaces opposed to a polymer electrolyte membrane, one of the catalyst layers serving as an oxidizer electrode, the other of the catalyst layers serving as a fuel electrode. A gas diffusion layer is disposed between the membrane electrode assembly 24 and the separator 25.

The gas diffusion layer is structured by a porous material such as carbon cloth and is a sheet material which allows reactants such as an oxidizer and a fuel to pass therethrough and which has conductivity.

The end plate 21 is provided with the fuel flow path inlet 26 to be connected to the fuel tank 10, for supplying the hydrogen gas to the fuel cell stack 11.

Next, a description will be made of a separator of this embodiment.

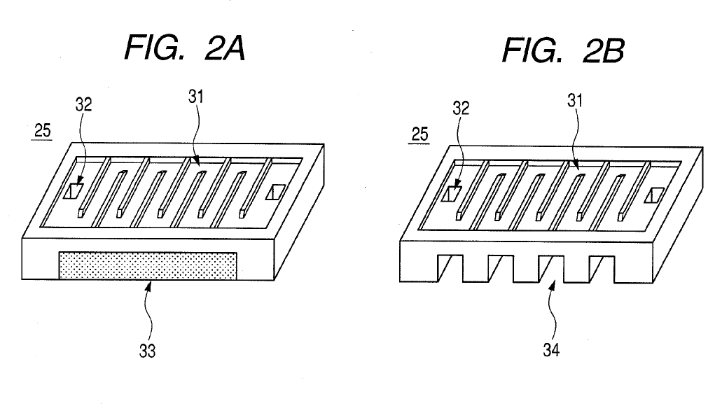

FIGS. 2A and 2B are each a view for describing a separator of this embodiment.

The hydrogen gas is distributed and supplied to a fuel flow path 31 of each of the fuel cell units through the fuel flow path inlet 26. A flow path between the fuel flow path inlet 26 and each of the fuel flow paths 31 is formed by overlapping through holes 32 with each other, which are provided in the separators 25.

On the oxidizer electrode side of the separator 25, an oxidizer flow path is formed.

The separator illustrated in FIG. 2A is an example in which a conductive porous material 33 is disposed as the oxidizer flow path.

The separator illustrated in FIG. 2B is an example in which multiple grooves 34 are formed as the oxidizer flow path.

The oxidizer flow path of each of the fuel cell units 23 has, at both ends thereof, a first opening portion 27 provided on one side surface of the separator (front side of the figure) and a second opening portion 28 provided on another side surface of the separator (back side of the figure.)

Air flowing through the oxidizer flow path is supplied to the oxidizer electrode of the membrane electrode assembly 24 through the gas diffusion layer.

A description will be made of blowing directions in the fuel cell apparatus according to this embodiment.

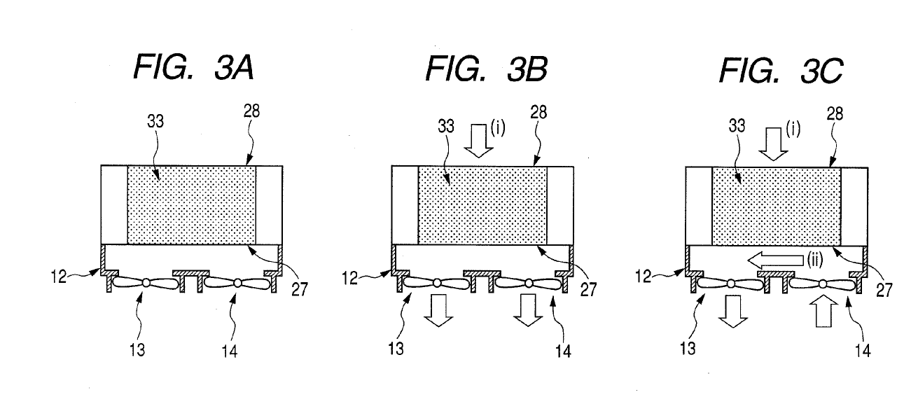

FIGS. 3A to 3C are sectional views taken along the line A-A of FIG. 1, for describing blowing directions in the fuel cell apparatus according to this embodiment.

In FIG. 3A, the manifold 12 is formed so as to face the first opening portion 27 of the oxidizer flow path.

Further, the second opening portion 28 is opened to an atmosphere.

The manifold 12 is provided with the first blowing fan 13 and the second blowing fan 14. By driving the first blowing fan 13 and the second blowing fan 14 air is allowed to flow through the oxidizer flow path or an inside of the manifold 12.

During the power generation of the fuel cell apparatus, the first blowing fan 13 is continuously driven. On the other hand, the second blowing fan 14 is driven depending on a humidity state of the fuel cell stack.

By the manifold 12, a surface of the fuel cell stack, the first opening portions 27, the first blowing fan 13, and the second blowing fan 14, a closed space is formed. The closed space is not necessarily a complete hermetically sealed space. The manifold 12 is provided so as to cover at least a part of the first opening portions 27.

FIGS. 3B and 3C are the schematic views in which flows of the air are illustrated.

FIG. 3B illustrates the flow of the air when both the first blowing fan 13 and the second blowing fan 14 are driven.

The air, which is introduced from the second opening portion 28 by the driving of the first blowing fan 13 and the second blowing fan 14, flows through the oxidizer flow path 33.

Regarding the air flowing through the oxidizer flow path 33, oxygen as a part of the air is consumed along with the power generation of the fuel cell apparatus, and the air contains a moisture content generated by the power generation and passes through the manifold 12 to be discharged through the first blowing fan 13 and the second blowing fan 14.

FIG. 3C illustrates the flow of the air when the first blowing fan 13 is driven and the second blowing fan 14 is not driven.

In the same manner as that of FIG. 3B, the air introduced from the second opening portion 28 flows through the oxidizer flow path 33 to be released to the manifold 12 through the first opening portion 27.

The air released into the manifold 12 is discharged, by the driving of the first blowing fan 13, through the first blowing fan 13 together with the air introduced into the manifold 12 through the second blowing fan 14, which is not driven.

When a comparison is made between the state of FIG. 3B and the state of FIG. 3C, a flow rate of the air (arrow (i)) flowing through the oxidizer flow path 33 is higher in the state of FIG. 3B.

That is, by the driving of the second blowing fan 14, the flow rate of the air flowing through the oxidizer flow path increases. When the driving of the second blowing fan 14 is stopped, the flow rate of the air flowing through the oxidizer flow path 33 decreases. When the humidity state of the fuel cell stack is determined to be the dried state, the driving of the second blowing fan 14 is stopped. As a result, the flow rate of the air flowing through the oxidizer flow path decreases and control is performed such that the fuel cell stack is humidified.

On the other hand, when the humidity state of the fuel cell stack is determined to be the excessively-humidified state, the driving of the second blowing fan 14 is performed. As a result, the flow rate of the air flowing through the oxidizer flow path increases and control is performed such that the fuel cell stack is dried.

As described above, in order to control the humidity state, while presence/absence of the driving of the second blowing fan 14 is controlled, the first blowing fan 13 is continuously driven.

The flow rate of the air in the oxidizer flow path, required for supplying an air amount required for power generation to the oxidizer electrode, is ensured by the driving of the first blowing fan 13. In the present invention, the “air amount required for power generation” refers to the minimum flow rate of the air required for the fuel cell apparatus to perform the power generation with a rated power generation. Fuel cell apparatuses having the same structure differ from each other in rated power generation depending on objects of application of those. Accordingly, the air amount required for power generation is set according to the object of application. The flow rate of the air which should be ensured by the driving of the first blowing fan 13 should be set according to the object of application.

On the other hand, the humidity state of the fuel cell stack can be controlled by presence/absence of the driving of the second blowing fan 14. In this case, while the control is performed by presence/absence of the driving of the second blowing fan 14, the control by a revolution number of the second blowing fan 14 may be involved therein.

By continuously driving the first blowing fan 13, the air amount required for power generation is secured.

Further, by the driving control of the second blowing fan 14, flow rate control of the air in the oxidizer flow path can be performed, so the humidity control appropriate for the humidity state of the fuel cell is enabled.

As described above, when the humidity state of the fuel cell stack is determined to be the dried state and the driving of the second blowing fan 14 is stopped, the flow rate of the air flowing through the oxidizer flow path decreases and the flow rate of the air (arrow (ii)) flowing through the manifold 12 increases.

The increase in the flow rate of the air flowing through the manifold 12 has an effect of promoting heat radiation from the fuel cell stack. Accordingly, the temperature of the fuel cell stack is lowered.

In a case where the temperature of the fuel cell stack is lowered when the humidity state of the fuel cell stack is the dried state, temperature of the air flowing through the oxidizer flow path is also lowered, so taking out of the moisture content is suppressed.

As a result, the moisture in the fuel cell stack increases, whereby resolving the dried state.

On the other hand, when the humidity state of the fuel cell stack is determined to be the excessively-humidified state to perform the driving of the second blowing fan 14, the flow rate of the air flowing through the oxidizer flow path increases and the flow rate of the air flowing through the manifold 12 decreases.

Since the flow rate of the air flowing through the manifold 12 decreases, the heat radiation from the fuel cell stack is suppressed. As a result, the temperature of the fuel cell stack rises.

In the case where the temperature of the fuel cell stack rises when the humidity state of the fuel cell stack is the excessively-humidified state, the temperature of the air flowing through the oxidizer flow path also rises, thereby increasing the taking out amount of the moisture content.

As a result, the water in the fuel cell stack decreases, thereby resolving the excessively-humidified state.

As described above, at the same time as the humidity control appropriate for the humidity state of the fuel cell stack, the temperature control appropriate for the humidity state of the fuel cell stack is also realized.

According to this embodiment, with the simple structure as described above and under the simple control, fine control of the humidity state is enabled. Accordingly, in the fuel cell apparatus suitable for the downsizing, stable power generation is enabled.

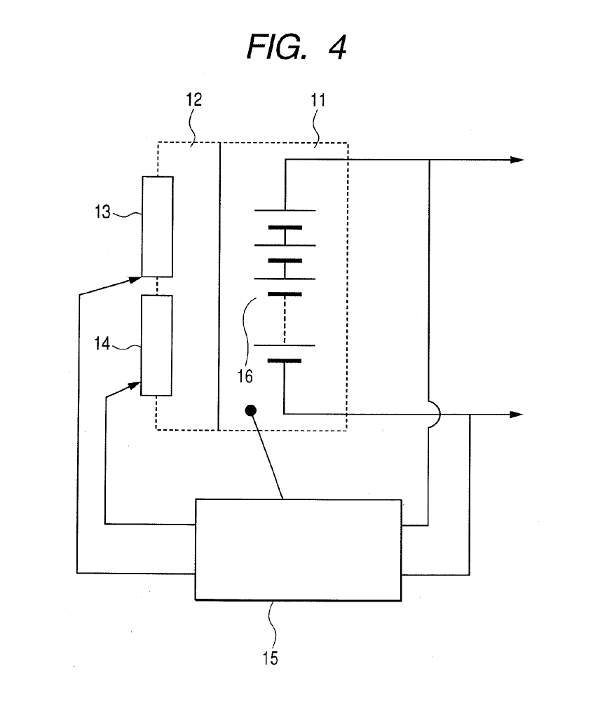

FIG. 4 is a schematic diagram for describing the control of the fuel cell device of this embodiment.

A control circuit 15 is supplied with electric power by an output of the fuel cell stack 11.

By the output of the fuel cell stack 11, electric power can be supplied to the outside through a DC-DC converter, for example.

The control circuit 15 determines the humidity state of the fuel cell based on the signal of a sensor 16 to control presence/absence of the driving or the revolution number of the second blowing fan 14.

The first blowing fan 13 is continuously driven irrespective of the humidity state of the fuel cell stack.

The humidity state of the fuel cell stack is determined based on at least a piece of information selected from the group consisting of a voltage of the fuel cell stack, a time variation of the voltage, voltage-current characteristics based on the voltage variation or the like involved in a change in an output current, and a temperature or humidity, which are detected by the sensor 16.

A signal related to the humidity state of the fuel cell stack determined based on those pieces of information is transmitted to the control circuit.

As a result, the fine control of the humidity state of the fuel cell is enabled, so the driving with high power generation efficiency is enabled.

In the above description, while the blowing direction at the time of driving the first blowing fan 13 and the second driving fan 14 is the direction indicated in FIG. 3B, the blowing direction is not limited to this.

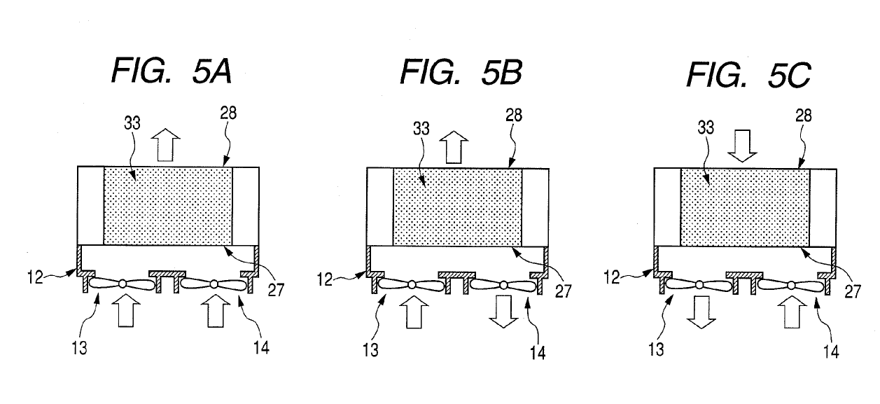

For example, blowing directions illustrated in structural examples of FIGS. 5A to 5C may be set.

In the structural example illustrated in FIG. 5A, similarly to the case of the structure of FIG. 3B, when the humidity state of the fuel cell stack is determined to be the dried state, the driving of the second blowing fan 14 is stopped.

On the other hand, when the humidity state of the fuel cell stack is determined to be the excessively-humidified state, the driving of the second blowing fan 14 is performed.

In the structures illustrated in FIGS. 5B and 5C, that is, the structural examples in which installation is performed such that the blowing directions at the time of driving the two blowing fans are opposite to each other, when the humidity state of the fuel cell stack is determined to be the excessively-humidified state, the driving of the second blowing fan 14 is stopped.

On the other hand, when the humidity state of the fuel cell stack is determined to be the dried state, the driving of the second blowing fan 14 is performed.

The flow rate of the air flowing through the oxidizer flow path 33 and the flow rate of the air flowing through the manifold 12 can be arbitrarily selected by the blowing fans and depending on the revolution number thereof.

The flow rates can be appropriately set by adjusting a flow path resistance from the first opening portion 27 to the second opening portion 28 and a flow path resistance from the first blowing unit 13 to the second blowing unit 14 through the manifold 12.

For example, depending on an area of the opening portions of the oxidizer flow path 33, a sectional area of the oxidizer flow path 33, a porosity of the conductive porous material, a shape of the grooves of the oxidizer flow path 33, or the like, the flow path resistance of the oxidizer flow path 33 is adjusted.

Further, the flow path resistance of the manifold 12 is determined by the shape of the flow path, the shape of the blowing fan in the opening portion, or the like. In this case, the flow path resistance of the manifold 12 means, for example, the flow path resistance in a state where the driving of the blowing fan 14 is stopped as illustrated in FIG. 3C.

In a normal operation, a flow rate of the air flowing through the oxidizer flow path, which is required for eliminating all the moisture content generated in the fuel cell stack, is smaller than a flow rate of the air flowing through the manifold 12, which is required for releasing the heat generated in the fuel cell stack.

Accordingly, it is desirable that the flow path resistance of the manifold 12 be set smaller than the flow path resistance of the oxidizer flow path 33.

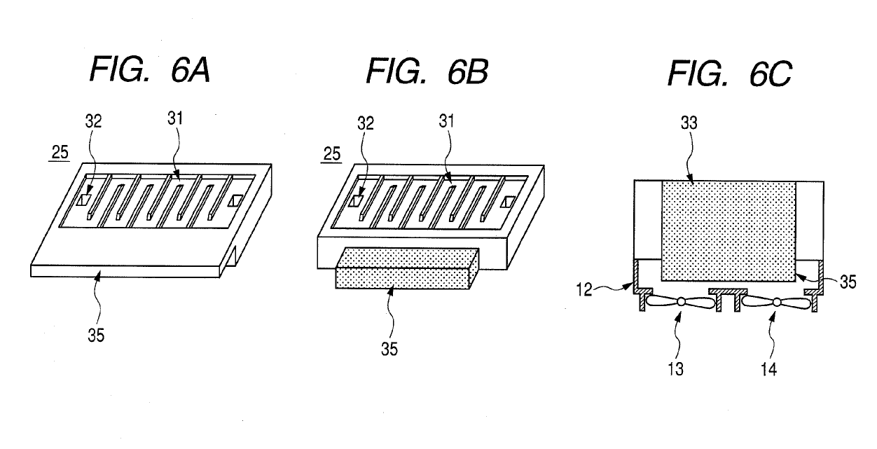

In order for the air flowing through the manifold 12 to effectively release the heat generated in the fuel cell stack, the separator as illustrated in each of FIGS. 6A and 6B may be used.

The separator of FIG. 6A is formed with a heat radiation fin 35 integrated with the separator on the manifold side.

The separator of FIG. 6B is provided to the conductive porous material on the manifold side so as to protrude therefrom.

FIG. 6C is a sectional views taken along the line A-A of FIG. 1 when the separator of FIG. 6B is used. As illustrated in FIG. 6C, a component material of the fuel cell stack extends on the manifold side to constitute the heat radiation fin 35, thereby increasing a contact area between the air flowing through the manifold and the heat radiation fin. As a result, heat can be effectively removed from the fuel cell stack.

By the increase in the flow rate of the air flowing through the manifold 12 and the heat radiation fin, a heat radiation rate can be increased. As a result, the temperature control can be performed more effectively, so a range in which the humidity state of the fuel cell can be controlled is widened, so stable power generation can be performed in a wider range of the environmental atmosphere and power generation state.

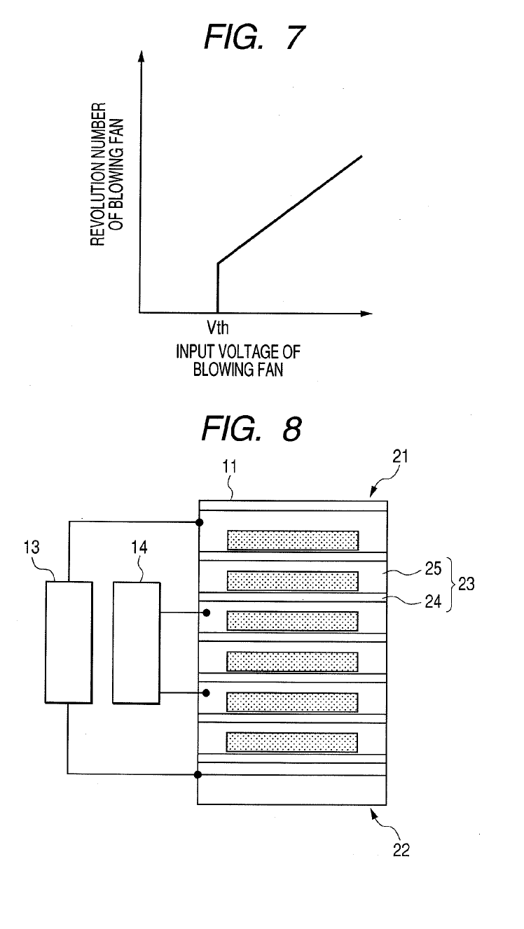

FIG. 7 illustrates a structural example of the blowing fan which can be used in this embodiment.

An input voltage to the blowing fan is represented by a horizontal axis, and the revolution number of the blowing fan is represented by a vertical axis. The revolution number of the blowing fan increases when the input voltage increases.

Further, when the voltage is equal to or lower than a certain voltage Vth, the blowing fan is not driven.

FIG. 8 illustrates a structural example of a method of electrically connecting the fuel cell stack 11 to the blowing fans 13 and 14 in the fuel cell device in which a need of the control circuit is eliminated.

The first blowing fan 13 is supplied with the electrical power from the larger number of the fuel cell units than that for the second blowing fan 14.

The blowing directions of the first and second fans are the directions illustrated in FIG. 3B or 5A.

When the fuel cell stack is in the appropriate humidity state, each of the fuel cell units in the fuel cell stack outputs a desired output voltage.

As a result, the voltage equal to or higher than the certain voltage Vth is supplied to both the first blowing fan 13 and the second blowing fan 14 by the fuel cell stack.

A design is achieved such that when both the first blowing fan 13 and the second blowing fan 14 are driven, the flow rate of the air flowing through the oxidizer flow path, which is sufficient for eliminating the moisture content generated by the power generation, is ensured.

Accordingly, the fuel cell stack is gradually transferred to the dried state.

When the fuel cell stack is transferred to the dried state, the output voltage of each of the fuel cell units is gradually lowered.

The second blowing fan 14 is supplied with the electric power from the smaller number of the fuel cell units than that for the first blowing fan 13. Accordingly, due to the reduction in the output voltage of the fuel cell, a supplied voltage of the second blowing fan 14 becomes equal to or lower than the certain voltage Vth before that of the first blowing fan 13. Then, the first blowing fan 13 is driven, but the driving of the second blowing fan 14 is stopped.

In this state, the design is achieved such that the flow rate of the air flowing through the oxidizer flow path 33 is higher than the flow rate required for the power generation, and is lower than the flow rate sufficient for eliminating the moisture content generated by the power generation.

Further, the flow rate of the air in the manifold 12 increases, so the heat radiation rate from the fuel cell stack also increases. Owing to the reduction in the flow rate of the air flowing through the oxidizer flow path and the reduction in the temperature of the fuel cell stack, the fuel cell stack is gradually humidified.

When the fuel cell stack becomes the appropriate humidity state, the output voltage of each of the fuel cell units becomes a normal value, so the driving of the second blowing fan 14 is also started.

In this manner, wirings are provided such that supplication of the electric power to the blowing fans is performed from the fuel cell stack and, at the same time, the first blowing fan is supplied with the electric power from the larger number of the fuel cell units than that for the second blowing fan, the humidity state of the fuel cell stack can be autonomously controlled.

The fuel cell of the present invention is not limited to the above-mentioned structure described in the above embodiment.

Further, the fuel cell apparatus of this embodiment can be implemented as an individual unit to be detachably mounted to portable electronic devices such as a digital camera, a digital video camera, a projector, a printer, and a notebook personal computer.

Further, the fuel cell apparatus of this embodiment can also be implemented by a mode in which only a power generation portion of the fuel cell apparatus is incorporated into the electronic device and the fuel tank is detachable.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority from Japanese Patent Application No. 2006-329948 filed on Dec. 6, 2006, which is hereby incorporated by reference herein.

What is claimed is:

1. A fuel cell apparatus which uses air as an oxidizer, comprising:
a fuel cell stack comprising multiple fuel cell units laminated to each other;
an oxidizer flow path having a first opening portion and a second opening portion at both ends thereof, for supplying the air to the multiple fuel cell units;
a manifold for covering at least a part of the first opening portion;
a first blowing unit provided to the manifold, for ensuring an air amount required for power generation in the fuel cell stack; and
a second blowing unit provided to the manifold, for controlling a humidity state of the fuel cell stack.

2. A fuel cell apparatus according to claim 1, wherein:
the first blowing unit comprises a blowing unit which is continuously driven; and
the second blowing unit comprises a blowing unit which is driven depending on the humidity state of the fuel cell stack.

3. A fuel cell apparatus according to claim 1, wherein each of the first blowing unit and the second blowing unit comprises a blowing fan whose revolution number can be controlled, the each of the first blowing unit and the second blowing unit ensuring, by controlling the revolution number of the blowing fan, the air amount required for the power generation in the fuel cell stack, and controlling the humidity state of the fuel cell stack.

4. A fuel cell apparatus according to claim 1, wherein the second blowing unit is driven based on at least one value selected from the group consisting of a voltage, a time variation of the voltage, voltage-current characteristics, and one of a temperature and a humidity.

5. A fuel cell apparatus according to claim 1, wherein a flow path resistance from the first opening portion to the second opening portion is larger than a flow path resistance from the first blowing unit to the second blowing unit through the manifold.

6. A fuel cell apparatus according to claim 1, wherein the fuel cell stack comprises a heat radiation fin protruding on a side of the manifold.

7. A fuel cell apparatus according to claim 1, wherein the first blowing unit and the second blowing unit are supplied with electric power from the fuel cell stack, the first blowing unit being supplied with a larger amount of the electric power than the electric power for the second blowing unit.
